(19) United States
(12) Patent Application Publication
(10) Pub. No.: US 2017/0114569 A1
(43) Pub. Date: Apr. 27, 2017

(54) DIRECTIONALLY-CONTROLLED LOCKING SYSTEM AND METHOD

(71) Applicant: Coby Kleinjan, Mansfield, TX (US)

(72) Inventor: Coby Kleinjan, Mansfield, TX (US)

(21) Appl. No.: 15/331,488

(22) Filed: Oct. 21, 2016

Related U.S. Application Data
(60) Provisional application No. 62/244,258, filed on Oct. 21, 2015.

(51) Int. Cl. E05B 49/00; E05B 17/00; G06F 3/16; E05B 65/00; G06F 3/0338; E05B 17/10; E05B 47/00

(52) U.S. Cl. CPC E05B 49/00; E05B 17/10; E05B 17/0083; E05B 47/0001; E05B 65/0075; G06F 3/0338; G06F 3/16

(57) ABSTRACT

A locking system includes an actuator for controlling actuation of a locking mechanism. An electronic control system controls the actuator. A directional input device is operable to receive directional inputs from a user where the directional inputs form an access code stored in a memory of the electronic control system and used for controlling the actuation of the locking mechanism.

### BACKGROUND

Locking mechanisms may be used to secure or restrict access to a variety of types of objects. For example, a locking mechanism may be used to lock, secure or restrict access to a cabinet or safe, a door, a gate, a desk, etc. The locking mechanism may be operated, for example, using a key, a rotating numeric dial, or a numeric keypad.

### BRIEF SUMMARY

According to one aspect of the present disclosure, a directionally-controlled locking system is disclosed. The directionally-controlled locking system includes an actuator for controlling actuation of a locking mechanism. An electronic control system controls the actuator. A directional input device is operable to receive directional inputs from a user where the directional inputs form an access code stored in a memory of the electronic control system and used for controlling the actuation of the locking mechanism.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is a diagram illustrating a top perspective view of a directionally-controlled locking system according to the present disclosure;

FIG. 2 is a diagram illustrating an enlarged view of a directional input mechanism of the directionally-controlled locking system of FIG. 1 according to the present disclosure; and

FIG. 3 is a block diagram illustrating the directionally-controlled locking system of FIGS. 1 and 2 according to the present disclosure.

### DETAILED DESCRIPTION

Embodiments of the present disclosure provide a directionally-controlled locking system that may be used with a variety of types of containers, enclosures, gates, doors, or other types of devices where secured access and control is desired. According to one embodiment, a locking system includes an actuator for controlling actuation of a locking mechanism. An electronic control system controls the actuator. A directional input device is operable to receive directional inputs from a user where the directional inputs form an access code stored in a memory of the electronic control system and used for controlling the actuation of the locking mechanism.

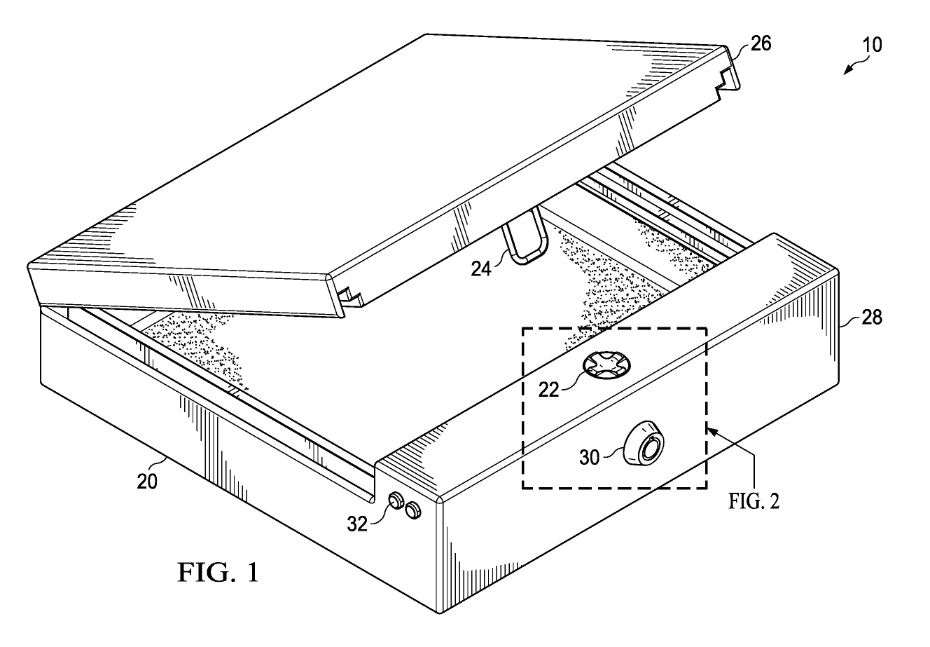

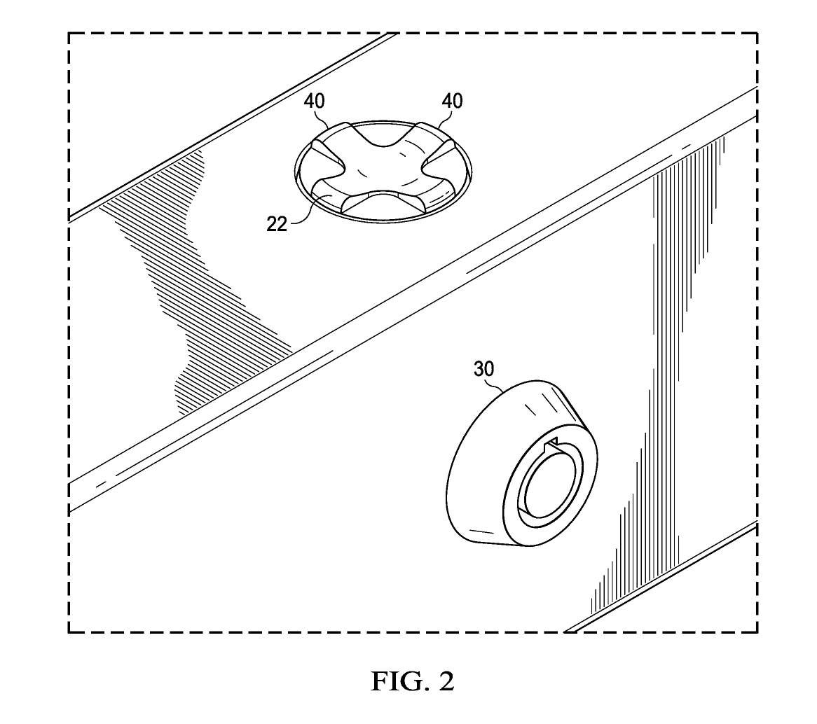

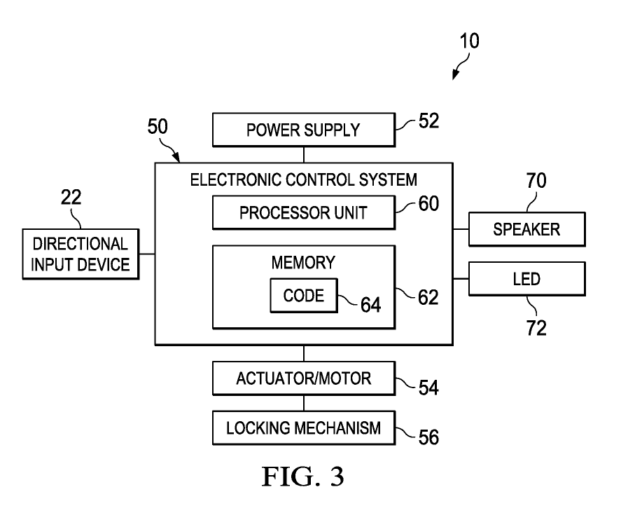

With reference now to the Figures and in particular with reference to FIGS. 1-3, diagrams illustrating a directionally-controlled locking method and system according to the present disclosure is illustrated. FIG. 1 is a diagram illustrating a top perspective view of a directionally-controlled locking system 10 according to the present disclosure; FIG. 2 is a diagram illustrating an enlarged view of a directional input mechanism of the directionally-controlled locking system 10 of FIG. 1 according to the present disclosure; and FIG. 3 is a block diagram illustrating the directionally-controlled locking system 10 of FIGS. 1 and 2 according to the present disclosure.

In FIGS. 1-3, system 10 comprises a lockable container 20 having a directional input device 22 for controlling the disengagement and/or deactivation of a locking mechanism for securing and/or locking container 20 in a closed position. For example, as best illustrated in FIG. 1, container 20 is depicted in an open position having an engagement member 24 extending downwardly from a lid 26 of container 20. In a closed position, engagement member 24 is engaged by a locking mechanism (not illustrated in FIG. 1) located in a base 28 of container 20 to secure lid 26 to base 28 in a closed position. In some embodiments, container 20 may also include a key-based mechanism 30 for unlocking container 20, and a power input mechanism 32 may be used to supply power to the locking mechanism (e.g., 9-volt battery terminals) in the event that an internal power supply of container has insufficient power to unlock container 20. In the illustrated embodiment, container 20 may include a safe or other type of lockbox; however, it should be understood that other types of enclosures or containers may be used.

In FIGS. 1-3, the locking mechanism is actuated (e.g., to disengage and/or open container 20) via directional input device 22. Directional input device 22 comprises a plurality of input elements 40 each corresponding to a different direction to form a directional electronic keypad. In the illustrated embodiment, four input elements 40 are depicted; however, it should be understood that a greater or fewer quantity of input elements 40 may be included. In the illustrated embodiment, input elements 40 comprise depressable regions of device 22 that receive input corresponding to four different directions (e.g., up, down, left, right), and those directional inputs correspond to a particular sequence to control the actuation and/or disengagement of the locking mechanism. For example, in some embodiments, device 22 may comprise a single input pad formed by a swivel-rocker mechanism such that different regions of the pad may be depressed downwardly to create an input signal corresponding to a particular direction. The directional inputs are fed to an electronic control system such that the directional sequence and/or code is programmed and stored in a memory module of the electronic control system to control access to the container 20.

In some embodiments, device 22 may comprise arrows or other directional indicators to identify or indicate a particular direction. In some embodiments, device 22 does not contain (i.e., is devoid of) any alphanumeric characters and/or symbols. For example, device 22 may be configured having directional indicating arrows (or even without arrows) and without having any alphanumeric characters to provide an additional level of security. As an example, consider a keypad having numeric or alphanumeric characters imprinted thereon. Regardless of a position or orientation of the keypad relative to a user, a user would be able to identify and locate a particular character and depress that character as part of a secure code or password. However, with embodiments of the present invention, an additional level of security may be obtained based on the position or orientation of device 22 relative to a user. As an example, consider that when a user of system 10 creates or otherwise inputs an access code to be stored in a memory module of the electronic control system of the container 20 for unlocking the container, the user orients the container 180 degrees from what would be considered the front of the container 20. The access code may be, for example, L-R-L-L-D-U (where L refers to left, R refers to right, D refers to down, and U refers to up directional inputs). However, if an unauthorized user attempts to open container 20 and believes he/she knows the access code, the orientation of the container relative to the unauthorized user must be correct for the L-R-L-L-D-U access code to work. For example, if the unauthorized user attempts to unlock container 20 from the perspective from the front of the container 20 using the L-R-L-L-D-U access code, the access code will not be accepted (e.g., the inputs would be opposite than what would be required to unlock the container 20). Thus, embodiments of the present invention enable an additional layer of security over alphanumeric character-based systems.

Directional input device 22 may be used on a variety of different types of storage-type units or lockable devices such as, but not limited to, safes, lock boxes of various sizes, file cabinets, utility closets, etc. Directional input device 22 may also be used on access control systems for gates, doors, etc.

FIG. 3 is a block diagram illustrating an embodiment of system 10. In the illustrated embodiment, system 10 comprises directional input device 22 electrically coupled to an electronic control system 50. A power supply 52 (e.g., a battery or other type of power supply) is coupled to electronic control system 50 and is used to provide power to electronic control system 50 and/or other devices of system 10 (e.g., an actuator/motor, LED, speaker, etc.). Electronic control system 50 controls an actuator/motor 54. Actuator/motor 54 may be used to engage/disengage a locking mechanism 56 of system 10 (e.g., a rod/lever or other type of structure engaging/disengaging engagement member 24). It should be understood that the type of locking mechanism used in system 10 may vary (e.g., an actuating lever, cylinder-type, cam-type, electromagnetic, etc.).

In FIG. 3, electronic control system 50 comprises a processor unit 60 and a memory 62 for storing code 64. Code 64 may comprise software and/or other programming for controlling various functions of system 10. Code 64 may also comprise the sequence of directional inputs for engaging/disengaging the locking mechanism of system 10. Code 64 may be loaded into memory 62 for execution by processor unit 60. The processes of the different embodiments may be performed by processor unit 60 using computer implemented instructions, which may be located in memory 62. These instructions may be referred to as program code, computer usable program code, or computer readable program code that may be read and executed by a processor in processor unit 60. Software/firmware of system 10 represented by code 64 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

In some embodiments, system 10 may be configured to provide audio and/or visual feedback of directional inputs using input device 22. For example, in response to a receiving a directional input (e.g., any direction or a particular direction), system 10 may provide an audio and/or visual feedback to the user. The audio feedback may comprise a particular frequency of “beep” or tone emitted by a speaker 70 (e.g., different frequency of beep tones for different directions, a different quantity or series of tones for different directions, etc.), and the visual feedback may comprise a multi-color LED 72 emitting a certain color corresponding to receipt of a particular directional input.

As described above, directional input device 22 receives one or more directional inputs that are converted to corresponding electronic signals transmitted to electronic control system 50. The directional inputs are analyzed by system 50 to determine whether the particular inputs entered/received correspond to the input needed to disengage the locking mechanism. If so, control system 50 causes the actuation of actuator/motor 54 to disengage the locking mechanism. In some embodiments, the reverse procedure may be used to lock container 20 (e.g., requiring the needed directional input to engage the locking mechanism).

In some embodiment, (e.g., where the storage unit is completely sealed, such as safes or lock boxes), system 10 may also comprise an interior light (via LED). The interior light may be illuminated in response to the correct entry sequence/code being input to system 10.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A locking system, comprising:
an actuator for controlling actuation of a locking mechanism;
an electronic control system for controlling the actuator; and
a directional input device for receiving directional inputs from a user, the directional inputs forming an access code stored in a memory of the electronic control system and used for controlling the actuation of the locking mechanism.

2. The locking system of claim 1, wherein the directional input device comprises a single input pad.

3. The locking system of claim 2, wherein the single input pad comprises a swivel-rocker mechanism.

4. The locking system of claim 1, further comprising a light emitting diode (LED) operable to provide a visual indication corresponding to a particular directional input received by the directional input device.

5. The locking system of claim 4, wherein the LED comprises a multi-color LED operable to produce a different color for each different directional input.

6. The locking system of claim 1, further comprising a speaker operable to provide an audio indication corresponding to a particular directional input received by the directional input device.

7. A locking system, comprising:
an electronic control system for controlling actuation of a locking mechanism; and
a directional input device without visual alphanumeric characters, the directional input device for receiving directional inputs from a user, the directional inputs forming an access code stored in a memory of the electronic control system and used for controlling the actuation of the locking mechanism.

8. The locking system of claim 7, wherein the directional input device comprises a single input pad.

9. The locking system of claim 8, wherein the single input pad comprises a swivel-rocker mechanism.

10. The locking system of claim 7, further comprising a light emitting diode (LED) operable to provide a visual indication corresponding to a particular directional input received by the directional input device.

11. The locking system of claim 10, wherein the LED comprises a multi-color LED operable to produce a different color for each different directional input.

12. The locking system of claim 7, further comprising a speaker operable to provide an audio indication corresponding to a particular directional input received by the directional input device.

13. A locking system, comprising:
a locking mechanism;
an actuator for controlling actuation of the locking mechanism;
an electronic control system for controlling actuation of the actuator;
a power supply for providing power to the electronic control system; and
a directional input device without visual alphanumeric characters, the directional input device including a single input pad swivel-rocker mechanism for receiving directional inputs from a user, the directional inputs forming an access code stored in a memory of the electronic control system and used for controlling the actuation of the actuator.

14. The locking system of claim 13, further comprising a light emitting diode (LED) operable to provide a visual indication corresponding to a particular directional input received by the directional input device.

15. The locking system of claim 14, wherein the LED comprises a multi-color LED operable to produce a different color for each different directional input.

16. The locking system of claim 13, further comprising a speaker operable to provide an audio indication corresponding to a particular directional input received by the directional input device.
